(19) United States
(12) Patent Application Publication
(10) Pub. No.: US 2024/0412721 A1
(43) Pub. Date: Dec. 12, 2024

(54) VIRTUAL ASSISTANT

(71) Applicant: Northway Technologies Inc., Irvine, CA (US)

(72) Inventors: Jeff BROWNING, Duluth, GA (US); Jody BURNETT, Cibolo, TX (US); Wayne LUDLUM, Fountain Valley, CA (US); Matthew James McDEVITT, Irvine, CA (US)

(21) Appl. No.: 18/736,270

(22) Filed: Jun. 6, 2024

Related U.S. Application Data
(60) Provisional application No. 63/506,914, filed on Jun. 8, 2023.

(51) Int. Cl. G10L 13/027; A63B 69/36; G10L 13/033; G10L 15/26

(52) U.S. Cl. CPC G10L 13/027; A63B 69/3605; G10L 13/033; G10L 15/26

(57) ABSTRACT

An example system implementing a virtual assistant can include: a processor; and memory storing instructions that, when executed by the processor, cause the system to: receive, at a mobile device, a request from an individual; determine contextual data; determine an intent and one or more parameters of the request; based at least in part on the intent, the one or more parameters, and at least some of the contextual data, generate a response to the request; synthesize the response to generate an audio output; and play the audio output using a playback device of the mobile device.

### BACKGROUND

In addition to swinging a club, a golfer may perform various other tasks related to playing golf. For instance, a golfer may select a club, evaluate course conditions, and perform administrative tasks. Some golfers may not have the time, knowledge, or skill to perform such tasks well. A caddy may help. Among other things, a caddy may provide a golfer with advice about a hole, a club selection, or aspects of the golfer's game. The caddy may also take care of administrative tasks. Despite the benefits, golfers often do not use a caddy. There may be a limited number of available caddies, it may be expensive to hire a caddy, or caddies may only be available during limited times. Most golf courses do not even provide a caddy service.

### SUMMARY

Embodiments disclosed herein relate to a virtual assistant.

In one aspect, an example system implementing a virtual assistant can include: a processor; and memory storing instructions that, when executed by the processor, cause the system to: receive, at a mobile device, a request from an individual; determine contextual data; determine an intent and one or more parameters of the request; based at least in part on the intent, the one or more parameters, and at least some of the contextual data, generate a response to the request; synthesize the response to generate an audio output; and play the audio output using a playback device of the mobile device.

### DESCRIPTION OF THE FIGURES

FIG. 1 shows an example environment including a virtual assistant.

FIG. 2 shows an example communication diagram between a mobile device and a services platform of the environment of FIG. 1.

FIG. 3 shows example logical components of the mobile device of FIG. 1.

FIG. 4 shows example logical components of the services platform of FIG. 1.

FIG. 5 shows example logical components of a server of the environment of FIG. 1.

FIG. 6 shows an example flowchart performed by the mobile device of FIG. 1.

FIG. 7 shows an example flowchart performed by the virtual assistant of FIG. 1.

FIG. 8 shows an example user interface of the mobile device of FIG. 1.

FIG. 9 shows another example user interface of the mobile device of FIG. 1.

FIG. 10 shows example components of the mobile device of FIG. 1.

### DETAILED DESCRIPTION

The disclosure is directed to a virtual assistant that leverages private (e.g., a physician's knowledge base), personal (e.g., health records), and publicly available (e.g., medical journals) data feeds to deliver customized, user-requested information in an artificially intelligent (AI) manner. The virtual assistant utilizes an AI-driven clone voice to communicate with users, providing a seamless and personalized experience. The virtual assistant is not limited to a specific domain or industry but can be adapted to various use cases

On a mobile device leveraging AI, the concept emerges as a revolutionary tool catering to individual needs across diverse domains. Through nuanced voice selection, this AI-powered companion adapts its tone and style to resonate with users, whether they're seeking fitness guidance, financial planning insights, academic support, or career coaching. Seamlessly integrating into users' daily routines, the virtual caddy harnesses the power of personalized algorithms to deliver tailored advice and motivation, fostering growth and empowerment. Its intuitive interface provides a conversational experience, akin to confiding in a trusted mentor, while its dynamic capabilities ensure relevance and efficacy in addressing users' unique aspirations and challenges. Whether navigating the slopes, charting career paths, or pursuing personal development, the universal-specific virtual caddy stands as a beacon of support and guidance, empowering users to reach their fullest potential in every facet of life.

The concept can represent a transformative breakthrough for individuals with physical and visual handicaps. Through seamless voice interactions, this AI-driven companion serves as a lifeline, offering unparalleled accessibility and support across various domains. For those with physical disabilities, the virtual caddy becomes an indispensable aid, providing personalized guidance in activities such as fitness routines, outdoor adventures, and career planning, adapting its assistance to accommodate individual capabilities and needs. Similarly, for individuals with visual impairments, the virtual caddy becomes an invaluable resource, offering auditory cues, descriptive guidance, and access to information previously inaccessible. By leveraging the power of AI-driven voice communication, this innovative tool not only enhances independence and empowerment but also fosters inclusivity, enabling individuals with disabilities to navigate life's challenges with newfound confidence and autonomy.

Some embodiments disclosed herein relate to a virtual golf caddy. The example virtual caddy may include a virtual caddy application and a virtual caddy server.

In example aspects, the golfer may use a mobile device (e.g., a phone, smart watch, smart speaker, etc.) to interact with the virtual caddy. The virtual caddy may interact with a golfer via voice. For example, the golfer may provide a request to the virtual caddy with a voice request using a microphone of the mobile device, and the virtual caddy may output an audio response using a speaker of the mobile device. In examples, the virtual caddy may alter the audio output so that it sounds like someone that the golfer trusts, such as a professional golfer or another trusted person.

In example aspects, the golfer may provide various types of requests to the virtual caddy. The requests may include—but are not limited to—requests related to the following: receiving a club recommendation; determining a characteristic of a hole or course, such as a distance, hazard characteristic, or topographical characteristic; determining historical play data for a golfer; determining an ambient condition, such as a wind strength and direction, a barometric pressure, a humidity, an elevation or altitude, a weather forecast, or a current weather condition, such as the temperature; determining statistics about a hole, course, or golfers; determining a location; or performing an administrative task, such as recording a score, scheduling a tee time, or ordering items.

As an example of aspects of the present disclosure, the golfer may verbally ask the virtual caddy, “Hey Caddy, what club should I use to land on the fairway 50 yards from the pin?” The mobile device may transcribe the request and determine that it is intended for the virtual caddy (e.g., based on a detection of the wake phrase “Hey Caddy”). The virtual caddy application may provide the request to the virtual caddy server. Additionally, the virtual caddy application may determine and send contextual data to the virtual caddy server, and the contextual data may include golfer data, hole data, location data, equipment data, and ambient condition data.

Continuing with the example, the virtual caddy server may receive the request and contextual data. Using a natural language understanding process, the virtual caddy server may determine an intent of the request (e.g., club selection recommendation) and, in some instances, one or more parameters of the request (e.g., “land on,” “fairway,” “50 yards from,” and “pin”). Using the intent, parameters, and contextual data, the golf caddy server may apply a machine learning model (e.g., a neural network trained to perform a multi-label classification task) to determine an answer to the request, which may be the recommended club (e.g., a 3 wood). Using a natural language generation process, the virtual caddy server may use the answer to generate a natural language response, such as, “Use your 3 wood and hit it low to drive through the wind.”

Continuing with the example, the virtual caddy server may provide the response to the virtual caddy application, which may synthesize the response to generate an audio output. The audio output may further be altered to sound like it is spoken by a celebrity or trusted person. The virtual caddy application may then play the audio output to the golfer via a media playback device of the mobile device.

In addition to the virtual caddy application, the golf mobile application on the mobile device may include other features. For example, among other features, the golf mobile application may include an application for tracking and analyzing golfer and course statistics, interacting with a golf community, and interacting with a club house service to schedule tee times or order items. In addition to including a virtual caddy server, the golf services platform may provide services related to operating a golf tournament, managing an online golfing community, or administrating a golf course. In some embodiments, the golf services platform may provide a service or a set of services to other enterprises or systems using a software-as-a-service model.

Aspects of the present disclosure may provide various technical advantages. For example, because the virtual caddy may be voice-based, the virtual caddy may be easy to use and may not require a golfer to physically interact with a device, thereby allowing the golfer to stow away the mobile device and perform other tasks. Yet still, the virtual caddy may generate a response and synthesize the response to generate an audio output that sounds like a person that the golfer trusts, thereby improving the golfer's experience. Additionally, because the virtual caddy may account for data related to a particular golfer, a particular hole, and various forms of contextual data that may be captured in real-time by sensors and other systems, the virtual caddy may provide customized and nuanced responses to golfer requests. The responses may be further improved by using deep learning techniques to make inferences based on a learned understanding of how various input features may affect one another and influence a response selection.

Furthermore, in some embodiments, a golf application disclosed herein may integrate, in a single application, various interactive features, such as a virtual caddy, a community application, a course services application, and a tournament application. Additionally, a scalable, integrated golf services platform may support the golf application across many users and various types of mobile devices, and the golf services platform may selectively expose applications and services that may be used by other programs and systems. As will be apparent, these are only some of the advantages provided by aspects of the present disclosure.

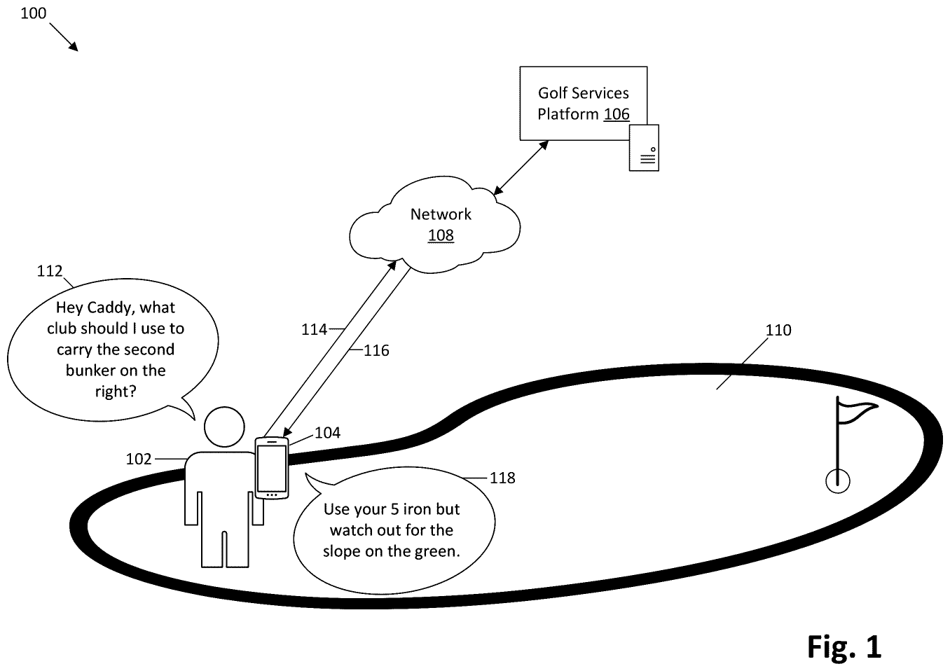

FIG. 1 illustrates an environment 100 in which aspects of the present disclosure may be implemented. The environment 100 includes a user 102, a mobile device 104, a golf services platform 106, and a network 108. In some embodiments, a virtual golf caddy may be implemented using components of one or more of the mobile device 104 or the golf services platform 106. As shown in the example of FIG. 1, the user 102 may be located on a golf course 110. The operations 112-118 illustrate an example use of aspects of the present disclosure.

The user 102 may, in some embodiments, be a golfer. For example, the user 102 may be playing golf on the golf course 110. The user 102 may have, or be located near, the mobile device 104, and the user 102 may use features of the mobile device 104. For example, the user 102 may communicate with a virtual caddy using a golf mobile application installed on the mobile device 104. Additionally, using the mobile device 104, the user 102 may access services provided by the golf services platform 106. Although illustrated as a single user in the example of FIG. 1, aspects of the present disclosure may be implemented with a plurality of users. For instance, a plurality of golfers may use a virtual caddy, the mobile device 104, or services of the golf services platform 106.

The mobile device 104 may, in some embodiments, be a smart device, such as a smart phone, smart watch or other wearable smart device, smart speaker, Internet of Things (IoT) device, or another device. In some embodiments, the mobile device 104 may be a collection of devices (e.g., a phone communicatively coupled to a watch). In some embodiments, the mobile device 104 may include virtual caddy. For example, a golf application may be installed on the mobile device 104, and the virtual caddy may be a feature of the golf application. In some embodiments, the golfer interacts with the virtual caddy on the mobile device 104 only via voice (e.g., without the use of displays or manual components of the mobile device 104). Furthermore, the mobile device 104 may include other components that may be software, hardware, or a combination of software and hardware.

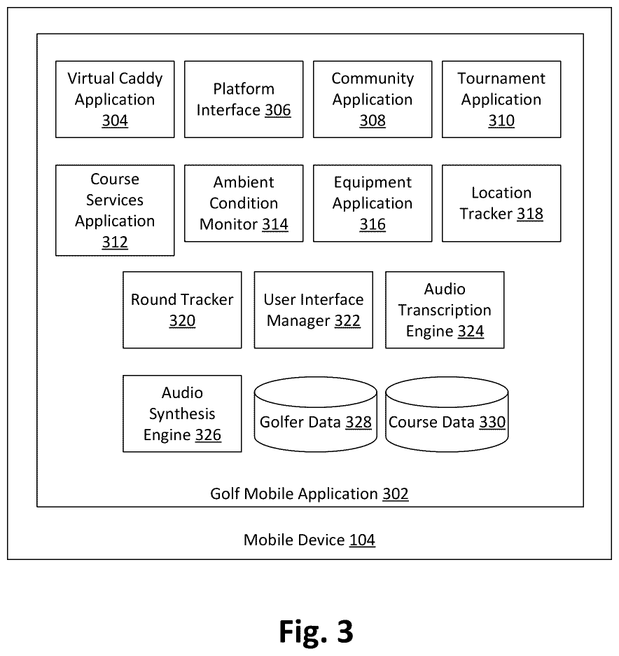

For example, the mobile device 104 may include one or more sensors or systems for determining one or more of an elevation or altitude, a wind direction and strength, a humidity level, a barometric pressure, a location, a time, or other data. In some instances, the mobile device 104 may call a third-party service (e.g., a weather-related API) to determine contextual data, such as ambient condition data. Furthermore, the mobile device 104 may include components for interacting with the user 102, such as a speaker, microphone, touch screen, button, or other component. Though illustrated as a single mobile device, the environment 100 may, in some embodiments, include a plurality of mobile devices (e.g., there may be a plurality of golfers, each of which may have a mobile device communicatively coupled with the golf services platform 106). Examples of the mobile device 104 and a golf mobile application installed thereon are illustrated and described below in connection with FIG. 3.

The golf services platform 106 may, in some embodiments, be a computing system that is remote from the user 102 and the mobile device 104. In some embodiments, the golf services platform 106 may be a cloud-based platform that may be accessed by the mobile device 104 over the internet. In some embodiments, the golf services platform 106 is communicatively coupled with the golf application installed on the mobile device 104.

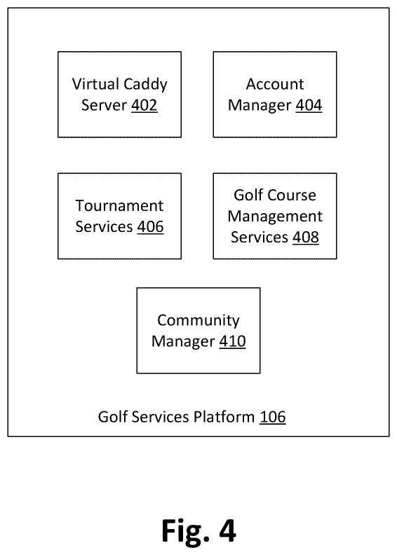

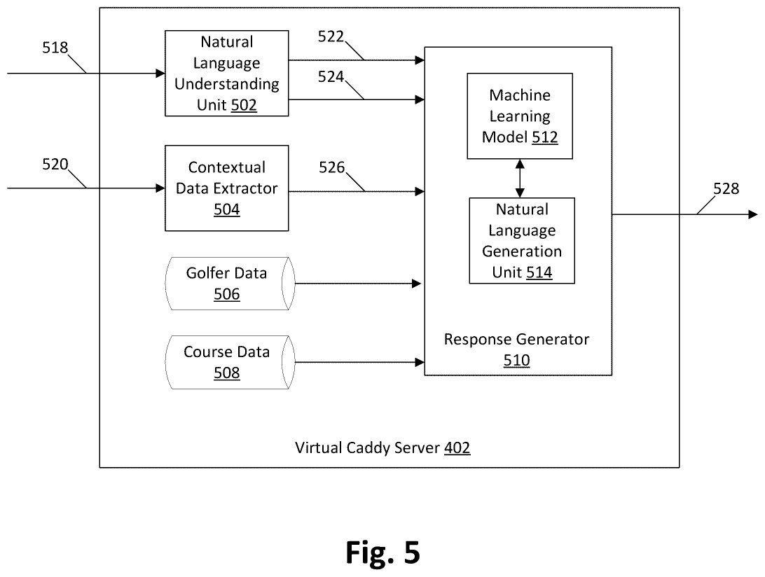

Applications of the golf application on the mobile device 104 may call the golf services platform 106 to perform an operation or to retrieve or provide data. Additionally, in some embodiments, the golf services platform may provide software as a service for golf-related systems and enterprises. Example components of the golf services platform 106 are illustrated and described below in connection with the FIGS. 4-5.

The network 108 may, in some embodiments, include a wireless network, a wired network, a virtual network, the internet, or another type of network. In some embodiments, the network 108 may be divided into subnetworks, and the subnetworks may be different types of networks or the same type of network.

The operations 112-118 illustrate an example use of aspects of the present disclosure. Specifically, the operations 112-118 illustrate an example use of a virtual caddy that may be implemented using aspects of the mobile device 104 and the golf services platform 106.

At the operation 112, the user may speak the following request: “Hey Caddy, what club should I use to carry the second bunker on the right?” The mobile device 104 may receive the request and determine that the request is directed to the virtual caddy, and the virtual caddy application may receive the request.

At the operation 114, the virtual caddy application may provide the request to a virtual caddy server on the golf services platform 106. Furthermore, the virtual caddy application may determine contextual data that may be relevant to the request and provide the contextual data to the virtual caddy server.

At the operation 116, the virtual caddy server on the golf services platform may provide a response to the request to the virtual caddy application on the mobile device 104. The virtual caddy application may synthesize the response to generate an audio output.

At the operation 118, the mobile device 104 may play the audio output using a media playback device. As illustrated, the audio output may be the following: “Use your 5 iron but watch out for the slope on the green.” In examples, the audio output may be altered so that it sounds as if it is being spoken by a celebrity or someone known by the user 102, as is further described below.

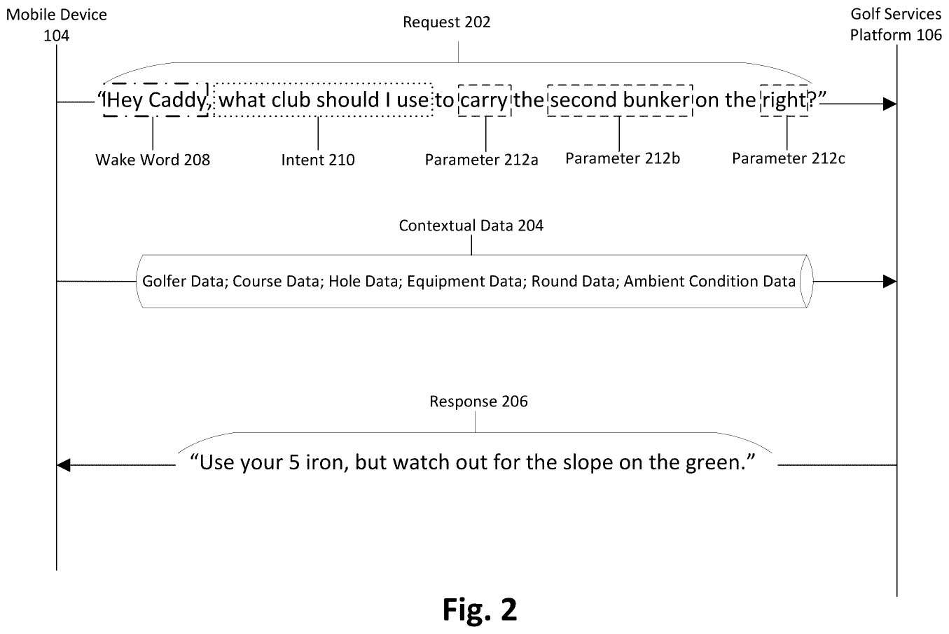

In the example of FIG. 1, the operations 112-118 are only an example of aspects of the present disclosure. Details of the virtual caddy, the mobile device 104, and the golf services platform 106 are further described in connection with the FIGS. 2-10. Furthermore, in some embodiments, the environment 100 may include more or fewer components than those illustrated in FIG. 1.

FIG. 2 illustrates a communication diagram showing example communications between the mobile device 104 and the golf services platform 106 of FIG. 1. In some embodiments, the communication diagram of FIG. 2 may illustrate example communication between a virtual caddy application on the mobile device 104 and a virtual caddy server on the golf services platform 106. In the example shown, the mobile device 104 may provide the request 202 and the contextual data 204 to the golf services platform 106. The golf services platform 106 may provide the response 206 to the mobile device 104.

The request 202 may be data representing a text string, text file, or audio file. In some embodiments, the mobile device 104 may receive an audio input from the user and transcribe the audio input to a text string, as shown by the request 202. In some embodiments, the request may include parts, such as a wake word 208, intent 210, and one or more parameters 212a-c. In the example shown, the wake word 208 corresponds to the text “Hey Caddy,” the intent corresponds to the text “what club should I use,” and the one or more parameters 212a-c correspond to the text “carry,” “second bunker,” and “right,” respectively. In some embodiments, the virtual caddy server may use the parts of the request 202 as part of generating the response 206

The wake word 208 may indicate that a user intended for the request 202 to be handled by a virtual caddy. For example, a golf application may, in some embodiments, actively listen for user utterances and discard such utterances unless a wake word is detected. In response to detecting the wake word, the golf application may process the utterance. In some embodiments, a user may customize the wake word (e.g., the user may customize the wake word to match a name of a voice that is used to output responses to requests).

The intent 210 may, in some embodiments, indicate a type of the request. For example, the virtual caddy may be configured to handle certain types of requests and, depending on the type of request, the virtual caddy may use a different process for responding to the request. As non-limiting examples, the virtual caddy may be configured to handle the following types of requests: recommending a club; determining a characteristic of a hole or course; determining an ambient condition; determining a statistic; determining a location; requesting other golf advice in the context of the golfer's historical performance and hole features; or performing an administrative task. In some embodiments, there may not be a direct correspondence between particular words and the intent.

For instance, an intent of the request 202 may be based on all the words in the request or based on words that are not next to one another. Furthermore, in some embodiments, the request may be provided to a natural language understanding model to determine an intent, and the natural language understanding model may apply different weights to different words of the request to determine an intent.

The one or more parameters 212a-c may correspond to additional data in the request. For example, the one or more parameters 212a-c may narrow the type of request indicated by the intent 210, or the one or more parameters 212a-c may provide additional details related to the intent 210. In some embodiments, the one or more parameters may depend on what the intent is. For example, if the intent is to receive a club recommendation, then the one or more parameters may relate to distances, hazards, locations, or other data related to selecting a club. If, however, the intent is to schedule a tee time, then the one or more parameters may relate to a time, location, and booking details. As another example, if the intent is to determine a location of an object, then the one or more parameters may include a type of the object (e.g., bunker, pin, water, etc.), its ordinal position (e.g., first, second, third, etc.), and its position of the left-right axis.

In some embodiments, the mobile device 104 may determine one or more parts of the request. In some embodiments, the golf services platform 106 may determine one or more parts of the request. As an example, the mobile device 104 may detect the wake word 208, and the golf services platform 106 may determine the intent 210 and the one or more parameters 212a-c. In some instances, a request may not have the parts illustrated. For example, a request may not have a wake word or may not have any parameters.

The contextual data 204 may, in some embodiments, include data related to a context of the request 202. The golf services platform 106 may use the contextual data 204 as part of generating the response 206. In some embodiments, the contextual data 204 may be determined at the mobile device 104 and provided to the golf services platform 106. In some embodiments, at least some of the contextual data 204 may be determined at the golf services platform 106. In some embodiments, the contextual data 204 may be provided from the mobile device 104 to the golf services platform 106 as structured data (e.g., as an XML file, JSON or DataFrame object, CSV file, XLS file, etc.). The contextual data 204 may include, but is not limited to, the following data: golfer data, course data, hole data, equipment data, round data, and ambient condition data.

The golfer data may be data related to the user who provided the request 202. In some embodiments, the golfer data may include a unique identifier that is used by the golf services platform 106 to identify a profile for the golfer. Additionally, in some embodiments, the golfer data may include physical characteristics such as gender, height, weight, or age. The golfer data may include the golfer's handicap, rounds played, scores by round, and various other metrics, such as average score, fairway percentage, percentage of shots or holes hit out-of-bounds or into a hazard, Greens in Regulation (GIR), or other statistics. Additionally, the golfer data may further include historical performance broken down by one or more subcategories, such as performance by club, by hole, by course, or by another metric.

For example, the historical performance data may indicate that, on average, the golfer hits his or her driver 220 yards, or that for par 4s, the golfer's GIR is 45%. In some embodiments, the golfer data may include data related to an amount and direction of spin the golfer puts onto shots (e.g., based on historical performance data). In examples, the spin data may be broken down by club. In some embodiments, the golfer data may be stored on one or more of a local database on the mobile device or on a database of the golf services platform 106. Additionally, in some embodiments, the golfer data may include account information for the golfer, such as one or more of a subscription level, email, username, password, or other information.

The course data may relate to a golf course that the user is currently playing, previously played, or is interested in playing. For example, the course data may include the course's location, characteristics of the course's holes, a course difficulty, course amenities (e.g., a range, putting green, shop, restaurant, etc.), or other data generally related to a course. In some embodiments, the course data may include data for each hole belonging to the course.

The hole data may relate to a particular hole of a golf course. In some embodiments, the hole data may be for a hole that a golfer is currently playing. For instance, based on a detected location of the golfer, data for the hole on which the user is located may be determined. The hole data may include par for the hole, hazard types and locations, hole elevations, distances between various aspects of the hole (e.g., from a tee box to green, from the back of a first hazard to the front of a second hazard, a distance of a dog leg, a distance from a user's current location to the pin or other aspect of the hole, etc.), historical performance by the golfer or community of golfers on the hole, or other data. For hazards, the hole data may, in some embodiments, include polygon data that describes the physical location and shape of the hazard.

Using the hole data, the virtual caddy may determine distances and angles from a golfer to aspects of a hole, such as to a hazard, the pin, or the green. As described below in connection with the location tracker 318, these distances and orientations may be determined without the use of images or videos; instead, a golfer location, a direction of play, and other data to determine relative distances and orientations.

The equipment data may relate to the golfer's equipment, such as the golfer's clubs. For example, the golfer may use a golf mobile application to input a set of clubs used for a round.

The round data may relate to a particular round of golf. In some instances, the round data may be for a current round that the golfer is playing. The round data may include the golfer's score, golfer data for the round (e.g., average driver distance, percentage of holes with three or more putts, etc.), whether the golfer is behind or ahead of schedule, whether the round is part of a tournament and, if so, data for the tournament, and other data related to the golfer's round. In some embodiments, the round data may include a direction of play.

The ambient condition data may relate to an ambient condition near or surrounding the golfer when the golfer provided the request 202. In some embodiments, one or more ambient conditions may be determined by sensors of the mobile device 104 or by devices with which the mobile device 104 is communicatively coupled. Example ambient condition data includes, but is not limited to, the following: an elevation or altitude, a wind direction and strength, a temperature, a humidity level, a barometric pressure, location coordinates, or other data.

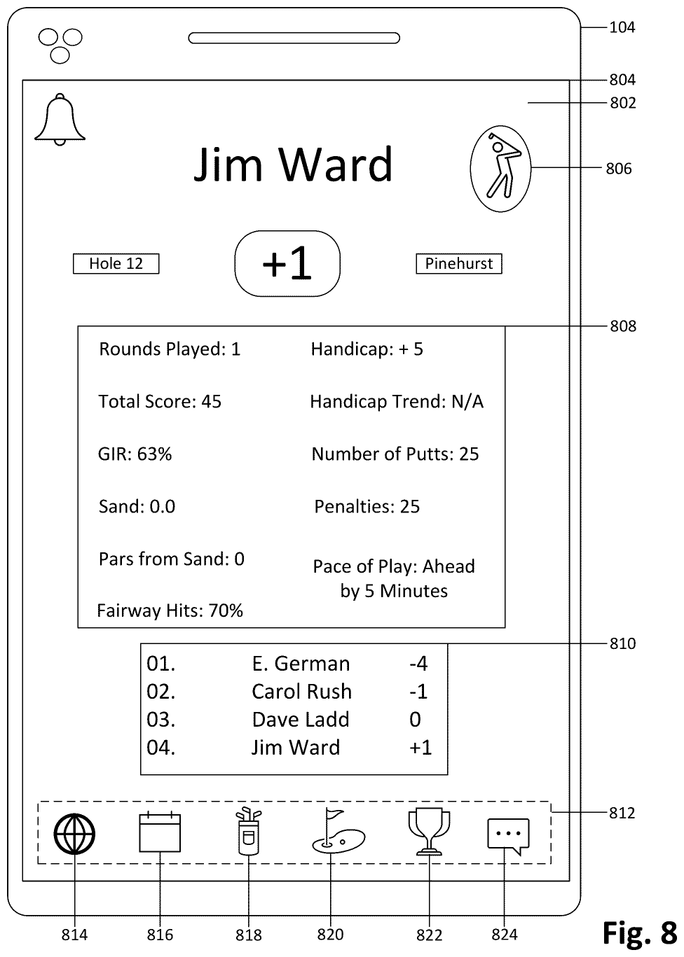

The response 206 may, in some embodiments, be data that is generated by the golf services platform 106 in response to the request 202. Examples of generating the response 206 are further described below in connection with the FIGS. 5 and 8. In some embodiments, the response 206 may be text data (e.g., a text string or text file). In some embodiments, the response 206 may be audio data. In some embodiments, the golf services platform 106 may stream the response 206 to the mobile device 104. Alternatively, in some embodiments, the mobile device 104 may download the response 206.

Referring generally to the FIGS. 3-5, example components of the mobile device 104 and the golf services platform 106 are illustrated. In some embodiments, the components illustrated in FIG. 3 may be part of the mobile device 104 of FIG. 1, and the components illustrated in FIGS. 4-5 may be part of the golf services platform 106. In some embodiments, however, components illustrated in connection with FIG. 3 may be part of the golf services platform 106, and components illustrated in connection with FIG. 4 or FIG. 5 may be part of the mobile device 104. Furthermore, in some embodiments, one or more of the components illustrated in connection with FIGS. 3-5 may be implemented in a device that is external to each of the mobile device 104 and the golf services platform 106.

FIG. 3 illustrates a block diagram of components of an example embodiment of the mobile device 104 of FIG. 1. In the example of FIG. 3, the mobile device 104 may include a golf mobile application 302. The mobile device 104 may also include components other than the golf mobile application 302, and the components of the golf mobile application 302 may be part of other systems or components of the mobile device 104. The golf mobile application 302 may be a native app that is installed on the mobile device 104. For example, the golf mobile application 302 may be a smart phone application or a smart watch application. The golf mobile application 302 may include various golf-related features to offer to a user. In some embodiments, the golf mobile application 302 may be communicatively coupled with the golf services platform 106.

In the example of FIG. 3, the golf mobile application 302 may include a plurality of components. The components of the golf mobile application 302 may be software, hardware, or a combination of software and hardware. In some embodiments, one or more components of the golf mobile application 302 illustrated in the example of FIG. 3 may overlap. In some embodiments, the golf mobile application 302 may include more or fewer components than those illustrated in the example of FIG. 3. In the example shown, the golf mobile application 302 includes a virtual caddy application 304, a platform interface 306, a community application 308, a tournament application 310, a course services application 312, an ambient condition monitor 314, an equipment application 316, a location tracker 318, a round tracker 320, a user interface manager 322, an audio transcription engine 324, an audio synthesis engine 326, golfer data 328, and the course data 330.

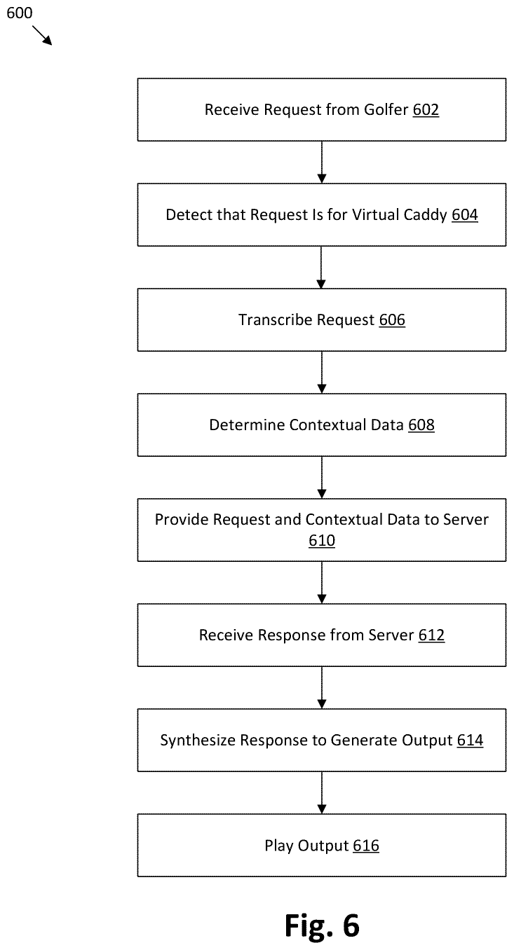

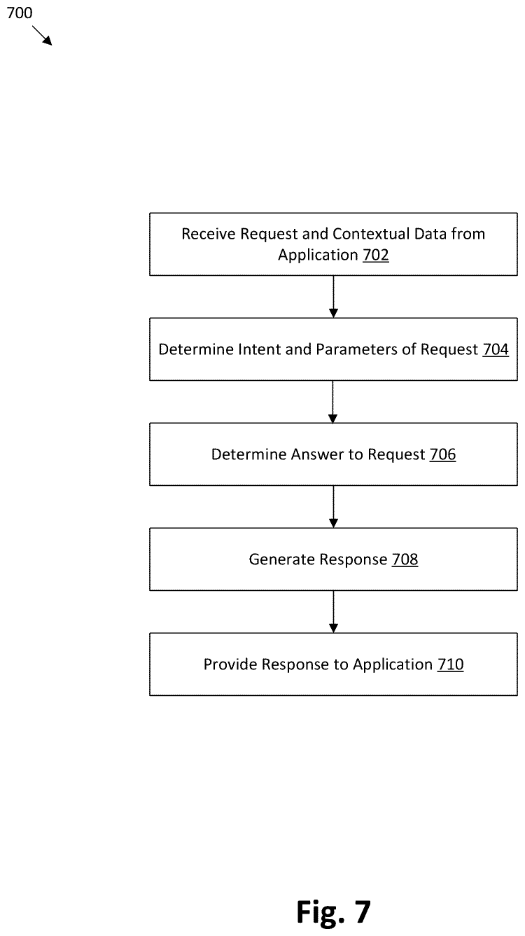

The virtual caddy application 304 may be a client-side application of the virtual caddy. The virtual caddy application 304 may be configured to receive a request from a golfer and perform an action in response to the request. In an example, the virtual caddy application 304 may query a server-side component of the virtual caddy (e.g., the virtual caddy server 402) to fulfill the request. The virtual caddy application 304 may further be configured to output a response to the golfer. In some embodiments, the virtual caddy application 304 may perform aspects of one or more of the methods 600 and 700 of FIGS. 6-7, which are further described below. To do so, the virtual caddy application 304 may, in some embodiments, use one or more other components of the golf mobile application 302 or the mobile device 104.

The platform interface 306 may facilitate communication between the golf mobile application 302 and the golf services platform 106. In some embodiments, the platform interface 306 may call application programming interfaces (APIs) of the golf services platform 106. In some embodiments, the platform interface 306 may expose APIs or endpoints for the golf services platform 106 to communicate with the golf mobile application 302. In some embodiments, the platform interface 306 may facilitate communication via the network 108 of FIG. 1.

The community application 308 may connect golfers with other golfers using the golf mobile application 302. For example, a golfer may message other golfers, share scores, make posts, share media such as pictures or videos, live stream video, buy and sell equipment, form groups, schedule tee times or tournament appearances, or perform other actions. In examples, the community application 308 may be coupled with a server-side community manager 410 on the golf services platform 106.

The tournament application 310 may collect and provide data related to a tournament. For example, the tournament application 310 may display a real-time leaderboard, information of golfers in the tournament, a golfer's performance in the tournament, scheduling information, tournament location, registration, and payment information, and other information related to a tournament. Furthermore, a golfer may use the tournament application 310 to input data (e.g., a score for a hole or a video of a long putt), and the tournament application 310 may distribute that data to the golf mobile application 302 of other players in the tournament. In some embodiments, the tournament application 310 may be communicatively coupled with server-side tournament services 406 on the golf services platform 106.

The course services application 312 may allow a golfer to use services offered by a golf course. For example, a golfer may use the course services application 312 to manage a tee time, order an item, inquire about a course, or perform another operation related to a course. In some embodiments, the course services application 312 may be communicatively coupled with server-side golf course management services 408 on the golf services platform 106.

The ambient condition monitor 314 may determine one or more ambient conditions. The ambient condition monitor 314 may include, or be coupled with, sensors of the mobile device 104. In examples, the ambient condition monitor 314 may receive a request from the virtual caddy application 304 to determine one or more ambient conditions, and in response, the ambient condition monitor 314 may use sensors or other systems to measure the one or more ambient conditions. Example ambient condition data is described above in connection with the contextual data 204 of FIG. 2.

The equipment application 316 may allow a golfer to track his or her equipment, such as clubs. For example, the golfer may use the equipment application 316 to notify the golf mobile application 302 that he or she is using a certain set of clubs for a round.

The location tracker 318 may determine a location of the mobile device 104 or golfer. For example, the location tracker 318 may be coupled with a GPS system. Additionally, in some embodiments, the location tracker 318 may determine location data for other devices or people (e.g., a location of a nearby device such as smart watch or Air Tag, a precise location of a pin, a location of a golfer associated with the mobile device 104 or another player in the golfer's group, a location of a nearby group, etc.). In some embodiments, the location tracker 318 may determine a direction of play of the golfer.

In some embodiments, the location tracker 318—or another component of the golf mobile application 302—may determine a location of objects based on the golfer's location, direction of play, and hole data. For example, the location tracker 318 may determine a distance and orientation of a hazard from the golfer (e.g., it may be determined that, from the golfer, a bunker is 80 yards to the right at a 35-degree angle when facing the pin). Advantageously, the golf mobile application 302 may determine object locations without using video or images, thereby obviating the inconvenience of removing and using a camera device and the lag caused by processing a video or photo. In some embodiments, determining such distances and orientations may be performed at the golf services platform 106.

As an example of determining a location of an object, the golfer may input a voice request to the virtual caddy. The intent of the voice request may be to determine a distance of an object from the golfer, and the parameters of the voice request may include an object type (e.g., bunker, pin, water, etc.), an ordinal number (e.g., first, second, etc.), and a position on the left-right axis (e.g., on the left, on the right, 30 degrees on the right, 10 degrees on the left, etc.). After receiving the request, the virtual caddy may determine a direction of play based on the golfer's current GPS location and the location of a center of the green on the hole that the golfer is currently playing. The virtual caddy may then be calculated as a perpendicular axis to the center path of the hole with an upward direction toward the pin.

Continuing with the example, the virtual caddy may then traverse the center path of the hole and identify the object specified in the voice request (e.g., “the second bunker on the right”). If the user specified an ordinal, then the virtual caddy may find the object that matches the specified ordinal. Having located the relevant object, the virtual caddy may calculate the current GPS location of the golfer to the object and then audibly announce the distance as part of a response. As illustrated by this example, the virtual caddy may locate objects and determine distances without the use of video or images; in fact, a golfer need not, in some embodiments, physically interact with a device at all to determine a distance to an object or to interact with the virtual caddy, as the golfer may simply speak a voice request and receive an audible response.

The round tracker 320 may receive, manage, and present data for a golfer's current round. For example, the round tracker 320 may receive and display statistics for a golfer's current round, an example of which is illustrated by the statistics 808 of FIG. 8. In some instances, the round tracker 320 may automatically detect updates to the golfer's round (e.g., based on a location, the round tracker 320 may detect that a golfer has moved from one hole to the next, or based on a location of a shot, the round tracker 320 may determine that the golfer hit into the sand). In some embodiments, the virtual caddy may update the round tracker 320 in response to a voice input. In some embodiments, the virtual caddy may use data form the round tracker 320 to generate a response. In some embodiments, the round tracker 320 may include input fields via which the golfer may input updates to a round.

The user interface manager 322 may display one or more user interfaces of the golf mobile application 302 on a screen of the mobile device 104. The user interface manager 322 may also receive and process inputs received via input fields of a displayed user interface. In some embodiments, one or more of the components of the golf mobile application 302 may be associated with a user interface. For example, one or more of the virtual caddy application 304, the community application 308, the tournament application 310, the course services application 312, the ambient condition monitor 314, the equipment application 316, the location tracker 318, or the round tracker 320 may be associated with a user interface.

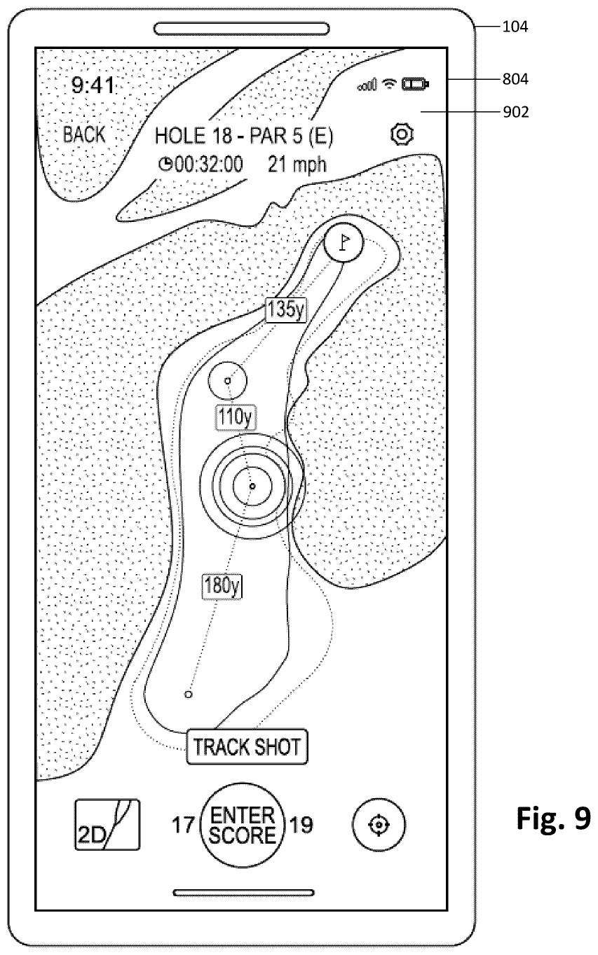

As an example, if the golfer wants to use the community application 308, the golfer may select an icon or option on a user interface of the golf mobile application 302, and in response, the user interface manager 322 may display a user interface associated with the community application 308. Example user interfaces 802 and 902 are illustrated and described below in connection with the FIGS. 8-9.

The audio transcription engine 324 may receive an audio input and output text corresponding to the audio input. In some embodiments, the audio input may be an audio data file and the output text may be a text data file. In some embodiments, the audio transcription engine 324 may implement a third-party audio transcription tool to transcribe audio to text.

The audio synthesis engine 326 may receive a text input and output an audio data file. In some embodiments, the audio synthesis engine 326 may use a third-party synthesizer to synthesize the text input. Additionally, in some embodiments, the audio synthesis engine may perform synthesis in a way—or alter the audio output in a way—so that it sounds like a pre-selected person. The pre-selected person may be a person that is selected by a developer of the golf mobile application. For example, the pre-selected person may be a professional golfer or caddy. In some embodiments, the golfer may select the pre-selected person. For example, using the virtual caddy application 304, the golfer may select a voice from among a plurality of voices made available by developers of the golf mobile application 302.

In some embodiments, the golfer may choose any person to be the pre-selected person whose voice may be used to speak the audio response. In some embodiments, to generate an audio output that sounds like the pre-selected person, the audio synthesis engine may need to train a model (e.g., a neural network) to alter audio so that it sounds like the pre-selected person. To do so, the model may need to train using audio files in which the pre-selected person is speaking.

The golfer data 328 may include data related to a user of the golf mobile application 302. Example data that may be included in the golfer data 328 is described above in connection with the contextual data 204 of FIG. 2.

The course data 330 may include data related to a golf course or hole of a golf course. Example course data and hole data that may be included in the course data 330 is described above in connection with the contextual data 204 of FIG. 2.

FIG. 4 illustrates a block diagram of components of an example embodiment of the golf services platform 106 of FIG. 1. In some embodiments, the golf services platform 106 may include an orchestration or interface unit that handles communication to and from the golf mobile application 302 (or another system) and between the components 402-410. In some embodiments, one or more of the components 402-410 may expose one or more APIs and a calling program may interact directly with one or more of the components 402-410. In some embodiments, the golf services platform 106 and one or more of the components 402-410 may be scalable and implemented in a cloud environment.

As an example, multiple instances of the client-side virtual caddy application 304 may be simultaneously communicating with the virtual caddy server 402. In response to more instances of the virtual caddy application 304 communicating with the virtual caddy server 402, more computing resources (e.g., processing power and memory) may be allocated to the virtual caddy server to 402 to handle the increased demand. In response to less demand for the virtual caddy server 402, less computing resources may be used, or computing resources may be allocated elsewhere.

In the example of FIG. 4, the golf services platform 106 includes a plurality of components, each of which may include software, hardware, or a combination of software and hardware. In the example shown, the golf services platform 106 includes a virtual caddy server 402, an account manager 404, tournament services 406, golf course management services 408, and a community manager 410. In some embodiments, one or more components of the golf services platform 106 illustrated in the example of FIG. 4 may overlap. In some embodiments, the golf services platform 106 may include more or fewer components than those illustrated in the example of FIG. 4.

The virtual caddy server 402 may be a server-side program of the virtual caddy. The virtual caddy server 402 may be configured to communicate with the virtual caddy application 304 of the golf mobile application 302. Example components of the virtual caddy server 402 and an example data flow of the virtual caddy server 402 are illustrated and described below in connection with FIG. 5.

The account manager 404 may manage accounts for users of the golf services platform 106. For example, the account manager 404 may handle registration of a user and management of account data. The account data for users may include a type of account (e.g., an individual golfer, a golf course, a team, a tournament organizer, etc.), details about the account, a subscription level of the account, payment information for the account, and other data.

The tournament services 406 may provide server-side functionality for the tournament application 310 of FIG. 3. For example, the tournament services 406 may receive, synch, and push data for a tournament so that participants in the tournament may receive tournament detail on their mobile devices in near real time. Additionally, the tournament services 406 may be configured to manage a plurality of tournament simultaneously.

The golf course management services 408 may provide server-side functionality for the course services application 312. In some embodiments, the golf course management services 408 may be communicatively coupled with systems (e.g., databases and servers) of golf courses that use the golf course management services 408. In an example, a golfer may use the course services application 312 of the golf mobile application 302 to book a tee time or perform another operation associated with a golf course. The golf course management services 408 may receive the request and interact with systems of the requested golf course to perform the operation. Thus, in some embodiments, the golf course management services 408, by handling communication with various golf course systems, allows a golfer to use the golf mobile application 302 to interact with disparate golf courses using a single platform.

The community manager 410 may provide server-side functionality for the community application 308. For example, the community manager 410 may route messages between users of the golf mobile application 302, and the community manager 410 may receive, synch, and display posts and other data input by a golfer using the community application 308. In examples, the community manager 410 may also handle the formation and data of golfer communities.

FIG. 5 is a block diagram of components of an example embodiment of the virtual caddy server 402 of FIG. 4. In the example of FIG. 5, the virtual caddy server 402 includes a plurality of components that may be used to generate a response to a golfer request that may be received by the virtual caddy at the virtual caddy application 304. In the example shown, the virtual caddy server 402 includes a natural language understanding unit 502, a contextual data extractor 504, golfer data 506, course data 508, a response generator 510, a machine learning model 512, and a natural language generation unit 514. Furthermore, in the example of FIG. 5, the operations 518-528 illustrate an example data flow between components of the virtual caddy server 402 when the virtual caddy server 402 generates a response to request.

The natural language understanding unit 502 may be a machine learning model or other program that performs a natural language understanding task on text. In some embodiments, the natural language understanding unit 502 may use a neural network. In some embodiments, the natural language understanding unit 502 may include a pretrained large language model that is fine-tuned to perform a task related to natural language understanding. In some embodiments, the natural language understanding unit may be configured to perform a text classification task (e.g., classify a request as having a certain type of intent), a named entity recognition task (e.g., recognizing one or more words as parameters), a keyword extraction task, a semantic labeling task, or another natural language processing task.

In the example shown, the natural language understanding unit 502 may receive a request 518. An example request is described above in connection with the request 202 of FIG. 2. In some embodiments, the natural language understanding unit 502 may tokenize the request 202, and the tokens may be converted into embeddings, which may be input into a machine learning model of the natural language understanding unit 502. In some embodiments, the natural language understanding unit 502 may output an intent 522 and one or more parameters 524 to the response generator 510, where the intent 522 and the one or more parameters 524 correspond to the request 518.

The contextual data extractor 504 may be a program that is configured to extract contextual data from a data file. In some embodiments, the contextual data extractor 504 may detect a file type of the data file, and the contextual data extractor 504 may, based on the file type, determine one or more values for contextual data. In some embodiments, the contextual data extractor 504 may be configured to extract only certain data depending on an intent of a request that is determined by the natural language understanding unit 502.

In the example shown, the contextual data extractor 504 may receive contextual data 520. An example of the contextual data 520 is described above in connection with the contextual data 204 of FIG. 2. The contextual data extractor 504 may determine one or more values of the contextual data 520 and provide the extracted contextual data 526 to the response generator 510.

The golfer data 506 may include data related to a user of the golf mobile application 302. Example golfer data is described above in connection with the contextual data 204 of FIG. 2. The course data 508 may include data related to a golf course or hole of a golf course. Example course data and hole data is described above in connection with the contextual data 204 of FIG. 2.

In some embodiments, at least some of the golfer data or course data may not be stored on the mobile device 104 and may instead be stored on the virtual caddy server 402 in the golfer data 506 and course data 508. In such embodiments, the contextual data 520 may include one or more of a golfer identifier, course identifier, or hole identifier and, using the one or more identifiers, the virtual caddy server 402 may retrieve the appropriate golfer, course, or hole data from the golfer data 506 and the course data 508. This data may then be provided to the response generator 510.

The response generator 510 may, in some embodiments, receive an intent 522, one or more parameters 524, extracted contextual data 526, golfer data, and course data and may output a response 528. In some embodiments, the response generator 510 may include a plurality of components including, for example, a machine learning model 512 and a natural language generation unit 514. In some instances, the response generator 510 need not use one or more of the machine learning model 512 or the natural language generation unit 514 to generate a response.

For example, if the request relates to scheduling a tee time, recording a score, sending or receiving data, determining an ambient condition, or some other topic, then the virtual caddy (e.g., the virtual caddy application 304 or the virtual caddy server 402) may perform the request by, in some examples, communicating with another system, and then the response generator 510 may generate a response indicating that a request was complete or incomplete, and with any follow-up data, such as a reason for which a request was incomplete.

The machine learning model 512 may be a model that determines an answer to the request 518. In some embodiments, the machine learning model 512 may generate an answer of a type that corresponds to a type of the intent 522. For instance, if the intent 522 is to receive a club selection, then the answer determined by the machine learning model 512 may be a club. As another example, if the intent 522 is to determine a probability (e.g., “Hey Caddy, what are the chances that I can cut the dog leg, clear the pond, and land on the approach using my 3 iron?”), then the answer may be a percentage.

In some embodiments, different machine learning models may be used for different intent types. In others, a common machine learning model may be used. In some embodiments, the machine learning model 512 may also be configured to infer a preference of a golfer. In some embodiments, features of the machine learning model 512 may include one or more of the request 518, the intent 522, one or more parameters 524, extracted contextual data 526, golfer data 506, course data 508, or other data. In some embodiments, the machine learning model 512 may be a neural network.

The natural language generation unit 514 may be a machine learning model or other program that may generate natural language output as the response 528. In some embodiments, the natural language generation unit 514 may be based on a pre-trained large language model such as a Generative Pre-trained Transformer (GPT)-based model or a Bidirectional Encoder Representations from Transformers (BERT)-based model. In examples, the large language model may be fine-tuned for the domain of golf or to generate responses as a virtual caddy.

In some embodiments, the natural language generation unit 514 may use an answer determined by the machine learning model 512 and one or more other inputs of the response generator 510 to generate the response 528. In some embodiments, the response 528 may—in addition to providing an answer using words that may be appropriate in the golf context—add other data to the response that may be helpful to the golfer based on the data received by the response generator 510.

In some embodiments, the response generator 510 may also generate a question for the golfer if more information may be needed. In some embodiments, the response 528 may be a text response. As shown, the virtual caddy server 402 may provide the response 528 to another system, such as the virtual caddy application 304 or another component of the golf services platform 106 or the mobile device 104.

Referring generally to the FIGS. 6-7, operations of a virtual caddy are illustrated and described. In some embodiments, the virtual caddy may include the client-side virtual caddy application 304 and the server-side virtual caddy server 402. In some embodiments, operations of the method 600 of FIG. 6 may be performed by the virtual caddy application 304, and operations of the method 700 of FIG. 7 may be performed by the virtual caddy server 402.

In some embodiments, however, operations of the method 600 may be performed by the virtual caddy server 402, and operations of the method 700 may be performed by the virtual caddy application 304. Additionally, in some embodiments, components other than the virtual caddy application 304 or the virtual caddy server 402 may perform one or more operations of the methods 600-700. Additionally, although example steps are shown, the steps can be performed in a different order, and fewer or more steps may be performed.

FIG. 6 is a flowchart of an example method 600 that may be performed by a virtual caddy. In some embodiments, aspects of the method 600 may be performed by the golf mobile application 302 or the virtual caddy application 304.

At step 602, the golf mobile application 302 may receive a request from a golfer. For example, using a microphone of the mobile device 104, the golf mobile application 302 may receive a voice request from a nearby golfer. In some embodiments, the golf mobile application 302 may be paired with the golfer, or the golfer may be in a group associated with the virtual caddy application 304.

At step 604, the golf mobile application 302 may determine that the request is intended to be handled by the virtual caddy. For example, the golf mobile application 302 may determine whether a wake word associated with the virtual caddy is present in the request. In response to determining that the wake word is present, the golf mobile application 302 may provide the request to the virtual caddy application 304 for processing. In examples, the golf mobile application may remove the work word from the request prior to the passing the request to the virtual caddy application 304.

In some embodiments, the golf mobile application 302 may log receipt of the request. In response to determining that the request is not intended for the virtual caddy (e.g., failing to detect a wake word or detecting a wake word associated with a different program), then the golf mobile application 302 may delete the request or provide the request to a different program.

At step 606, the virtual caddy application 304 may transcribe the request. For example, the virtual caddy application 304 may generate a text version of a voice-based request. To do so, the virtual caddy application 304 may, in some embodiments, use the audio transcription engine 324.

At step 608, the virtual caddy application 304 may determine contextual data. For example, the virtual caddy application 304 may determine values related to golfer data, course data, hole data, equipment data, round data, ambient condition, or other contextual data. Example contextual data that may be determined by the virtual caddy application 304 is described above in connection with the contextual data 204 of FIG. 2.

At step 610, the virtual caddy application 304 may provide the request and contextual data to a server, such as the virtual caddy server 402, to receive a response to the request. In some embodiments, the virtual caddy application 304 may call an API exposed by the virtual caddy server 402 and use the API to provide the request and contextual data to the virtual caddy server 402. Advantageously, by providing data to the virtual caddy server 402 to determine a response, the virtual caddy may distribute a compute from the mobile device 104 to the golf services platform 106, which may have more available computing resources than the mobile device 104.

In some instances, however, the virtual caddy application 304 may not provide data to the virtual caddy server 402 to generate a response. Rather, the virtual caddy application 304 may determine the response. For example, in some embodiments, if the request intent relates to determining an ambient condition, recording a score, or performing another task that may be performed using resources or data available on the mobile device 104, then the virtual caddy application 304 may fulfill the request and generate a response using components of the mobile device 104 and the golf mobile application 302.

At step 612, the virtual caddy application 304 may receive a response from the server. For example, the virtual caddy application 304 may receive a text file that includes the response from the virtual caddy server 402. In some embodiments, the virtual caddy application 304 may stream the response from the virtual caddy server 402.

At step 614, the virtual caddy application 304 may synthesize the response to generate an audio output. For example, the virtual caddy application 304 may apply the audio synthesis engine 326 to generate audio data corresponding to the response. Additionally, as described above in connection with the audio synthesis engine 326 of FIG. 3, the virtual caddy application 304 may alter the audio output to sound like a pre-selected person.

At step 616, the virtual caddy application 304 may play the audio output. In some embodiments, the virtual caddy application 304 may play the audio output using a playback device (e.g., speaker) of the mobile device 104. In some embodiments, the virtual caddy application 304 may play the audio output via a speaker of a device other than the device that received voice request.

FIG. 7 is flowchart of an example method that may be performed by a virtual caddy. In some embodiments, aspects of the method 700 may be performed by the golf services platform 106 or the virtual caddy server 402.

At step 702, the virtual caddy server 402 may receive a request and contextual data from the virtual caddy application 304. An example request and an example of contextual data are described above in connection with FIG. 2. In some embodiments, the golf services platform 106 may include one or more APIs, one of which may be to generate a response to a request. In some embodiments, the virtual caddy server 402 may receive the request and contextual data when a program calls an API to get a response to a request from the virtual caddy server 402.

At step 704, the virtual caddy server 402 may determine an intent and one or more parameters of the request. To do so, the virtual caddy server 402 may, in some embodiments, apply the natural language understanding unit 502 of FIG. 5. In some embodiments, there may not be an intent in the request or there may not be any parameters. Additionally, in some embodiments, one or more of the intent or parameters may have already been determined by the virtual caddy application 304, in which case the virtual caddy server 402 may not reevaluate the request to determine the request or parameters. In some embodiments, the virtual caddy server 402 may also extract contextual data values from the contextual data received by the virtual caddy application 304.

At step 706, the virtual caddy server 402 may determine an answer to the request. In some embodiments, the virtual caddy server 402 may apply the machine learning model 512 of FIG. 5 to determine an answer. In some instances, however, the virtual caddy server 402 may use a different program or system (e.g., one of the components 404-410 of the golf services platform 106 or information from the mobile device 104) to determine an answer to the request, as described above in connection with the response generator 510 of FIG. 5.

In some embodiments, the virtually caddy server 402 may, as part of determining an answer to a request, apply additional logic or factors to the result of the machine learning model 512 or other program. For example, if the virtual caddy server 402 is determining how far a golfer should hit or what club the golfer should use, the virtual caddy server 402 may adjust the answer based on wind conditions. In some embodiments, a wind direction and strength may be determined by querying a third-party weather service and comparing the information received from the weather service (e.g., the wind is currently 10 miles per hour in a northwest direction) with a golfer's current location and direction of play. As a result, the wind direction and strength relative to the golfer may be determined and may be used to determine a response to a request. For instance, if the golfer has a tailwind, then the virtual caddy server 402 may recommend that the golfer club down or not hit as far. In contrast, if the golfer faces a headwind, then the virtual caddy server 402 may recommend that the golfer club up or hit further. The magnitude of the adjustment may depend on both the speed of the wind and the relative angle of the wind to the golfer (e.g., if facing a direct headwind, then the adjustment may be larger than if facing a headwind coming at a forty-five degree angle).

At step 708, the virtual caddy server 402 may generate a response. In some embodiments, the virtual caddy server 402 may use the natural language generation unit 514 and the response generator 510 to generate the response, each of which are described above in connection with FIG. 5. In some embodiments, the response may be a text string or file. In some embodiments, the response be audio data or an audio file.

At step 710, the virtual caddy server 402 may provide the response to an application. For example, the virtual caddy server 402 may provide the response to the virtual caddy application 304. In some embodiments, the virtual caddy server 402 may stream the response to the virtual caddy application 304. In some embodiments, the virtual caddy server 402 may provide the response to another program or system. In some embodiments, the virtual caddy server 402 may log or store the response. In some embodiments, the response may be used to further train a machine learning model.

FIG. 8 illustrates an example user interface 802 of the golf mobile application 302 of FIG. 3. In the example shown, the user interface 802 is displayed via the screen 804 of the mobile device 104 of FIG. 1. In some embodiments, when a golfer selects an icon of the golf mobile application 302 on the mobile device 104, the user interface 802, or a user interface including aspects of the user interface 802 may be displayed. In the example shown, the user interface 802 includes a profile icon 806, statistics 808, a leaderboard 810, and the icons 812. However, the configuration, data, and features of the user interface may vary depending on the embodiment.

The profile icon 806 may be a link to a golfer profile. For example, in response to a user click or touch on the profile icon 806, the golf mobile application 302 may display configurable profile information for a golfer that is logged into an account on the golf mobile application 302. The information may include a biographical information for the golfer, historical performance data for the golfer, images and other media, and other information.

The statistics 808 may be text that provides data about a golfer, such as a golfer that is logged into the golf mobile application 302. The statistics 808 may include statistics for a current round, a current day, or historical golfer performance data. In some embodiments, the statistics 808 may be configurable. For example, a user of the golf mobile application 302 may customize which statistics are displayed in the region illustrated by the statistics 808. In some embodiments, aspects of the statistics 808 may be updated in real time as a golfer plays.

The leaderboard 810 may provide statistics of a one or more golfers. For example, the leaderboard 810 may include a plurality of scores of other golfers. The other golfers may, in some instances, be a part of a tournament. In other instances, the other golfers may be part of a group or community of golfers that is not playing in a tournament. In some embodiments, aspects of the leaderboard 810 may updated in real time as the golfers play. In some embodiments, the leaderboard 810 may show statistics other than current scores (e.g., the leaderboard 810 may show handicaps, a pace of play, GIR, etc.).

The icons 812 may include one or more selectable icons that are associated with aspects of the golf mobile application 302. The golf mobile application 302 may, in response to a user selection of an icon of the icons 812, display a different user interface corresponding to an application or program associated with the selected icon. In some embodiments, one or more of the icons 812 may be a deep link that is associated with another mobile application (e.g., a mobile application installed on the mobile device 104 or available in a mobile app store).

In the example of FIG. 8, the icons 812 include a community icon 814, a scheduling icon 816, an equipment icon 818, a course icon 820, a tournament icon 822, and a chat icon 824. Selecting the community icon 814 may, in some embodiments, allow a user to access aspects of the community application 308. Selecting the scheduling icon 816 may, in some embodiments, allow a user to access aspects of the course services application 312. Selecting the equipment icon 818 may, in some embodiments, allow a user to access aspects of the equipment application 316. Selecting the course icon 820 may, in some embodiments, allow the user to access aspects of an application or program related to a course that is being played. For example, the golf mobile application 302 may display one or more of a course map, course data, golfer locations, or recommended shots or clubs. An example of a user interface that includes course information is illustrated and described below in connection with FIG. 9. Selecting the tournament icon 822 may, in some embodiments, allow a user to access aspects of the tournament application 310. Selecting the chat icon 824 may, in some embodiments, allow the user to communicate with other users of the golf mobile application 302. Additionally, in some embodiments, the chat icon 824 may lead to features for communicating with golf course services related to ordering food or beverages, ordering items, communicating with a club house, or reporting an issue with the course.

In some embodiments, the user interface 802 may also include a component that, when selected, allows a user to interact with the virtual caddy. In some embodiments, in response to a selection of such a component, the virtual caddy may actively listen for a request from the user. In some embodiments, however, the virtual caddy may listen for a request even if a component of a user interface is not selected.

FIG. 9 illustrates an example user interface 902 of the golf mobile application 302 of FIG. 9. In the example shown, the user interface 902 is displayed via the screen 804 of the mobile device 104 of FIG. 1. As shown, the user interface 902 illustrates an interactive map of a hole. The hole may be, for example, a hole that a golfer is currently playing, a hole that the golfer already played, or a hole that the golfer is going to play.

In the example shown, the user interface 902 illustrates features of the hole, such as a pin location, a fairway, a rough, an out-of-bounds area, and an elevation. Furthermore, the user interface 902 provides information about shots for the hole, such as distances and locations of shots. In some embodiments, the illustrated shots may be actual shots hit by a golfer when playing the hole. In some embodiments, the illustrated shots may be shots that are recommended by the virtual caddy. In some embodiments, the user interface 902 may be configured to toggle between a two-dimensional and a three-dimensional representation of the hole. Additionally, in some embodiments, the user interface 902 may include other features, such as an input field for tracking a shot, entering a score, toggling between different holes, or tracking a location.

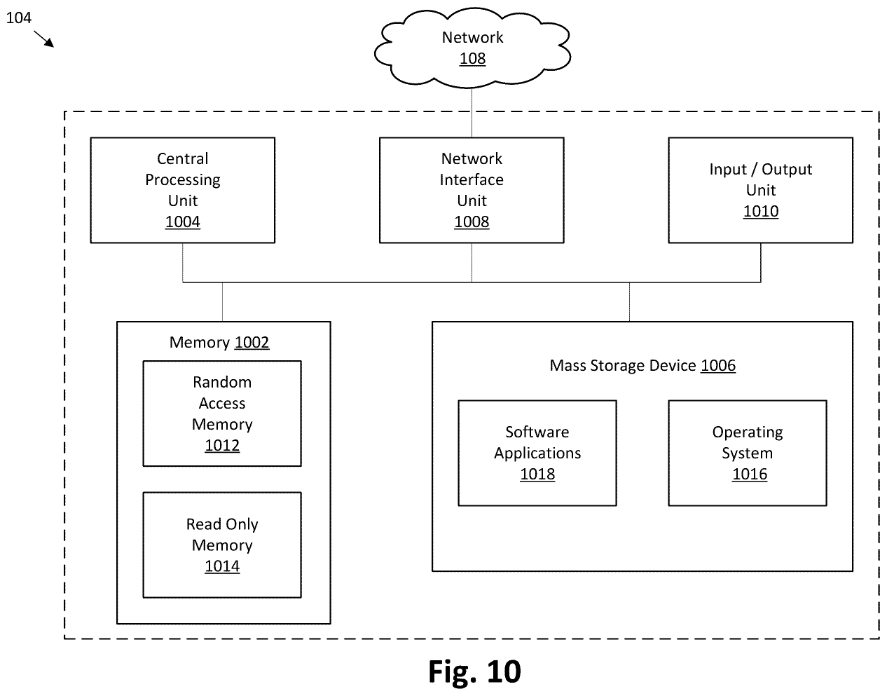

FIG. 10 illustrates a block diagram of example components of the mobile device 104. The other computing devices, such as the golf services platform 106, can be similarly configured. In examples, the computing devices can be configured in various ways, such as the traditional client/server configuration.

The mobile device 104 can include various components, including a memory 1002, a central processing unit (or processor) 1004, a mass storage device 1006, a network interface unit or card 1008, and an input/output unit 1010 (e.g., video interface, a display unit, and an external component interface). In other embodiments, computing devices are implemented using more or fewer hardware components. For instance, in another example embodiment, a computing device does not include a video interface, a display unit, an external storage device, or an input device.

The term computer readable media as used herein may include computer storage media, which can include random access memory 1012 and/or read only memory 1014. Computer storage media may include volatile and nonvolatile, removable and non-removable media implemented in any method or technology for storage of information, such as computer readable instructions, data structures, program modules, or other data. The memory includes one or more computer storage media capable of storing data and/or instructions.

As used in this document, a computer storage medium is a device or article of manufacture that stores data and/or software instructions readable by a computing device. In different embodiments, the memory is implemented in different ways. For instance, in various embodiments, the memory is implemented using various types of computer storage media. Example types of computer storage media include, but are not limited to, dynamic random access memory (DRAM), double data rate synchronous dynamic random access memory (DDR SDRAM), reduced latency DRAM, DDR2 SDRAM, DDR3 SDRAM, Rambus RAM, solid state memory, flash memory, read-only memory (ROM), electrically-erasable programmable ROM, and other types of devices and/or articles of manufacture that store data.

The processing system includes one or more physical integrated circuits that selectively execute software instructions. In various embodiments, the processing system is implemented in various ways. For example, the processing system can be implemented as one or more processing cores. In this example, the processing system can comprise one or more Intel microprocessors. In another example, the processing system can comprise one or more separate microprocessors.

The secondary storage device includes one or more computer storage media. The secondary storage device stores data and software instructions not directly accessible by the processing system. In other words, the processing system performs an I/O operation to retrieve data and/or software instructions from the secondary storage device. In various embodiments, the secondary storage device is implemented by various types of computer-readable data storage media. For instance, the secondary storage device may be implemented by one or more magnetic disks, magnetic tape drives, CD-ROM discs, DVD-ROM discs, Blu-Ray discs, solid state memory devices, Bernoulli cartridges, and/or other types of computer-readable data storage media.

The network interface card enables the computing device to send data to and receive data from a communication network. In different embodiments, the network interface card is implemented in different ways. For example, in various embodiments, the network interface card is implemented as an Ethernet interface, a token-ring network interface, a fiber optic network interface, a wireless network interface (e.g., Wi-Fi, WiMAX, etc.), or another type of network interface.

The video interface enables the computing device to output video information to the display unit. In different embodiments, the video interface is implemented in different ways. For instance, in one example embodiment, the video interface is integrated into a motherboard of the computing device. In another example embodiment, the video interface is a video expansion card. In various embodiments, the display unit can be a cathode-ray tube display, an LCD display panel, a plasma screen display panel, a touch-sensitive display panel, an LED screen, a projector, or another type of display unit. In various embodiments, the video interface communicates with the display unit in various ways. For example, the video interface can communicate with the display unit via a Universal Serial Bus (USB) connector, a VGA connector, a digital visual interface (DVI) connector, an S-Video connector, a High-Definition Multimedia Interface (HDMI) interface, a DisplayPort connector, or another type of connection.

The external component interface enables the computing device to communicate with external devices. In various embodiments, the external component interface is implemented in different ways. For example, the external component interface can be a USB interface, a Fire Wire interface, a serial port interface, a parallel port interface, a PS/2 interface, and/or another type of interface that enables the computing device to communicate with external devices. In different embodiments, the external component interface enables the computing device to communicate with different external components. For example, the external component interface can enable the computing device to communicate with external storage devices, input devices, speakers, phone charging jacks, modems, media player docks, other computing devices, scanners, digital cameras, a fingerprint reader, and other devices that can be connected to the computing device. Example types of external storage devices include, but are not limited to, magnetic tape drives, flash memory modules, magnetic disk drives, optical disc drives, flash memory units, zip disk drives, optical jukeboxes, and other types of devices comprising one or more computer storage media. Example types of input devices include, but are not limited to, keyboards, mice, trackballs, stylus input devices, keypads, microphones, joysticks, touch-sensitive display screens, and other types of devices that provide user input to the computing device.

The memory stores various types of data and/or software instructions. For instance, in one example, the memory stores a Basic Input/Output System (BIOS), and an operating system 416. The BIOS includes a set of software instructions that, when executed by the processing system, cause the computing device to boot up. The operating system includes a set of software instructions that, when executed by the processing system, cause the computing device to provide an operating system that coordinates the activities and sharing of resources of the computing device, including one or more possible software applications 1018.

While the examples above are described with reference to the golf industry, the concepts provided herein are not so limited.

A golf caddy's skill set involves more than just carrying clubs; they provide strategic advice, course knowledge, emotional support, and more. Here are some other markets where these skills could be applicable:

Tennis: In tennis, the virtual assistant could serve as a strategic advisor, analyzing opponents' playstyles, providing feedback on technique, and offering emotional support during matches.

Skiing/Snowboarding: the virtual assistant could assist skiers or snowboarders by providing guidance on terrain, conditions, and equipment choices. It could also offer tips on technique and help plan routes down the mountain.

Sailing: In sailing, the virtual assistant could act as a navigator, helping to plot courses, read wind and weather conditions, and make tactical decisions during races or long journeys.

Hiking/Outdoor Adventure: the virtual assistant could provide guidance on trail routes, wilderness survival skills, and equipment choices. It could also offer encouragement and support during challenging hikes or expeditions.

Corporate Consulting/Coaching: the virtual assistant could serve as a metaphorical guide for professionals navigating their careers. It could offer advice on career paths, networking strategies, and work-life balance, helping individuals make informed decisions and achieve their goals.

Fitness Coaching: the virtual assistant could create customized workout plans, offer nutrition advice, and provide motivation and encouragement to help individuals achieve their fitness goals.

Financial Planning: the virtual assistant could analyze spending habits, offer budgeting advice, and provide guidance on investments and saving strategies.

Education/Tutoring: the virtual assistant could offer academic support, helping with homework, exam preparation, and study skills for students. It could also provide guidance on career planning and goal setting.

Personal Development/Life Coaching: the virtual assistant could serve as a mentor and coach, offering guidance on personal growth, goal setting, and overcoming challenges. It could provide accountability and support to help individuals make positive changes in their lives.

Healthcare: the virtual assistant could provide personalized health information, appointment scheduling, medication reminders, and wellness tips based on individual health data and preferences.

Travel: the virtual assistant could assist with travel planning, itinerary management, destination recommendations, and real-time travel alerts based on user preferences, travel history, and current conditions.

The virtual assistant can integrate data from various sources, including but not limited to user profiles, historical data, real-time data feeds, third-party APIs, and databases. By analyzing this data and understanding user preferences, behavior patterns, and contextual information, the virtual assistant can generate relevant and actionable insights to enhance user experiences and productivity.

Furthermore, the AI-driven clone voice adds a unique element to the virtual assistant, allowing users to interact in a familiar and engaging manner. The clone voice can be customized to emulate different personalities, accents, and speech styles, enhancing the user experience and building rapport with users over time.

In summary, the virtual assistant described herein revolutionizes the way individuals access and interact with information and services, offering a tailored and intelligent solution to meet diverse needs across various domains. In each of these markets, the virtual assistant is adapted to the specific needs and challenges of the target audience, whether it's providing strategic advice, emotional support, or practical guidance.

What is claimed is:

1. A system implementing a virtual assistant, the system comprising:
a processor; and
memory storing instructions that, when executed by the processor, cause the system to:
receive, at a mobile device, a request from an individual;
determine contextual data;
determine an intent and one or more parameters of the request;
based at least in part on the intent, the one or more parameters, and at least some of the contextual data, generate a response to the request;
synthesize the response to generate an audio output; and
play the audio output using a playback device of the mobile device.

2. The system of claim 1, wherein the virtual assistant is a virtual golf caddy, and wherein the individual is a golfer.

3. The system of claim 2, wherein the request includes one or more of requesting a club recommendation or requesting information related to a hole that the golfer is currently playing.

4. The system of claim 2,
wherein the instructions, when executed, further cause the system to determine golfer data for the golfer, the golfer data including a historical performance of the golfer or preferences of the golfer; and
wherein generating the response to the request is further based at least in part on the golfer data.

5. The system of claim 2, wherein the contextual data includes one or more of an ambient condition, a location of the golfer, or course data for a course that the golfer is currently playing.

6. The system of claim 2, wherein synthesizing the response to generate the audio output comprises editing the audio output to sound like a pre-selected person.

7. The system of claim 6, wherein editing the audio output to sound like the pre-selected person comprises inputting the audio output into a neural network trained to alter the audio output to sound like the pre-selected person.

8. The system of claim 2, wherein generating the response to the request is performed at a server that is remote from the mobile device and the golfer.

9. The system of claim 8, wherein the instructions, when executed by the processor, further cause the system to, prior to playing the audio output using the playback device of the mobile device, stream the response from the server to the mobile device.

10. The system of claim 2,
wherein the instructions, when executed by the processor, further cause the system to display a user interface of a golf mobile application installed on the mobile device; and
wherein the user interface includes an interactive map, an input field, and golfer data for the golfer.

11. The system of claim 1, wherein generating the response to the request comprises applying a machine learning model configured to receive, as input, the intent, the one or more parameters, and the at least some of the contextual data.

12. The system of claim 1, wherein the instructions, when executed, further cause the system to transcribe the request prior to determining the intent and the one or more parameters.

13. A method for implementing a virtual assistant, the method comprising:
receiving, at a mobile device, a request from an individual;
determining contextual data;
determining an intent and one or more parameters of the request;
based at least in part on the intent, the one or more parameters, and at least some of the contextual data, generating a response to the request;
synthesizing the response to generate an audio output; and
playing the audio output using a playback device of the mobile device.

14. The method of claim 13, wherein the virtual assistant is a virtual golf caddy, and wherein the individual is a golfer.

15. The method of claim 14, wherein the request includes one or more of requesting a club recommendation or requesting information related to a hole that the golfer is currently playing.

16. The method of claim 14, further comprising:
determining golfer data for the golfer, the golfer data including a historical performance of the golfer or preferences of the golfer; and
wherein generating the response to the request is further based at least in part on the golfer data.

17. The method of claim 14, wherein the contextual data includes one or more of an ambient condition, a location of the golfer, or course data for a course that the golfer is currently playing.

18. The method of claim 14, wherein synthesizing the response to generate the audio output comprises editing the audio output to sound like a pre-selected person.

19. The method of claim 18, wherein editing the audio output to sound like the pre-selected person comprises inputting the audio output into a neural network trained to alter the audio output to sound like the pre-selected person.

20. The method of claim 14, wherein generating the response to the request is performed at a server that is remote from the mobile device and the golfer.
